(19) United States
(12) Patent Application Publication
(10) Pub. No.: US 2014/0277943 A1
(43) Pub. Date: Sep. 18, 2014

(54) Display Apparatus and Method for Assisting Parking

(71) Applicant: LG INNOTEK CO., LTD., Seoul (KR)

(72) Inventors: Sang Yong Lee, Seoul (KR); Dae Seung Kim, Seoul (KR)

(21) Appl. No.: 14/349,965

(22) PCT Filed: Sep. 20, 2012
(86) PCT No.: PCT/KR2012/007542

§ 371 Date: Apr. 4, 2014

(30) Foreign Application Priority Data
Oct. 6, 2011 (KR) 10-2011-0101579

(51) Int. Cl. B60W 30/06

(52) U.S. Cl. CPC B60W 30/06
USPC 701/41

(57) ABSTRACT

A display apparatus and method for assisting parking is disclosed, the method comprising combining images of all directions of a vehicle photographed by a photographing unit installed on the vehicle into an around view, generating an expected travel trace of the vehicle using steering angle information of the vehicle, overlaying the expected travel trace of the vehicle on the around view, and displaying the overlaid around view along with the expected travel trace of the vehicle, wherein the expected travel trace includes a first expected travel trace made by rear wheels of the vehicle and a second expected travel trace made by front wheels of the vehicle.

### TECHNICAL FIELD

The teachings in accordance with exemplary embodiments of this invention relate generally to display apparatus and method for assisting parking.

### BACKGROUND ART

Recently, devices for consumer satisfaction and consumer convenience are widely propagated with regard to power performance of a vehicle. For non-limiting examples, the trend is that an integrated display device enabling a driver to grasp a vehicular state at a glance using front, rear, right and left cameras for assisting parking of a vehicle is popularized.

A driver can learn an obstacle around a vehicle and a distance to the obstacle using a distance measuring sensor mounted on front and rear sides of the vehicle and a display device during parking of the vehicle.

Conventionally, limited information has been provided that simply displays a front view or a rear view of a vehicle or provides a distance to an obstacle for recognizing the obstacle. As a result, there is a need for a display device and a display method for parking assistance capable of enhancing a user satisfaction that is more instinctive than that of the conventional technique.

In the conventional parking assistance system, an expected travel trace of a vehicle was displayed based on a trace of rear wheels. There is a problem in the conventional parking assistance system thus described in that an area to which the vehicle actually travels is not fully displayed to result in collision with an obstacle, causing an unexpected damage to a driver

### DISCLOSURE OF INVENTION

### Technical Problem

Accordingly, embodiments of the present invention may relate to a display apparatus and method for assisting parking that substantially obviates one or more of the above disadvantages/problems due to limitations and disadvantages of related art, and it is an object of the present invention to provide a display apparatus and method for assisting parking configured to be instinctive and to enhance a user satisfaction.

Technical problems to be solved by the present invention are not restricted to the above-mentioned, and any other technical problems not mentioned so far will be clearly appreciated from the following description by skilled in the art.

### Solution to Problem

In order to accomplish the above object, an exemplary embodiment of the present invention provides a display apparatus for assisting parking, the apparatus comprising: a plurality of photographing units mounted on a vehicle to obtain images of all directions of the vehicle; an image combining unit combining the images photographed by the photographing unit into an around view; a travel trace generating unit generating an expected travel trace of the vehicle using steering angle information of the vehicle to overlay the expected travel trace on the around view; and a display unit displaying the overlaid around view, wherein the travel trace generating unit generates a first expected travel trace based on rear wheels of the vehicle and a second expected travel trace based on front wheels of the vehicle.

In an exemplary embodiment of the present invention, the plurality of photographing units may comprise first, second, third and fourth photographing unit installed on a front side, a rear side, a left side and a right side of the vehicle to obtain an image of each direction.

In an exemplary embodiment of the present invention, the third and fourth photographing units installed on left and right sides of the vehicle may be installed at bottom ends of the left and right side mirrors of the vehicle.

In an exemplary embodiment of the present invention, the around view may include a scene of the vehicle viewed from an area above the vehicle.

In an exemplary embodiment of the present invention, the apparatus may further comprise a transceiver receiving the steering angle information.

In an exemplary embodiment of the present invention, the transceiver may receive the steering angle information from a steering angle sensor of the vehicle.

In an exemplary embodiment of the present invention, the first and second expected travel traces may be updated in real time in response to steering angle of steering wheels of the vehicle.

In an exemplary embodiment of the present invention, the apparatus may further comprise a speaker audibly announcing a presence of an obstacle to a driver.

In another general aspect of an exemplary embodiment the present invention, there is provided a method for assisting parking, the method comprising: combining images of all directions of a vehicle photographed by a photographing unit installed on the vehicle into an around view; generating an expected travel trace of the vehicle using steering angle information of the vehicle; overlaying the expected travel trace of the vehicle on the around view; and displaying the overlaid around view along with the expected travel trace of the vehicle, wherein the expected travel trace generating step may include generating a first expected travel trace based on rear wheels of the vehicle and a second expected travel trace based on front wheels of the vehicle.

In an exemplary embodiment of the present invention, the around view may include a scene of the vehicle viewed from an area above the vehicle.

In an exemplary embodiment of the present invention, the first and second expected travel traces may be updated in real time in response to steering angle of steering wheels of the vehicle.

### Advantageous Effects of Invention

A parking apparatus and method for parking assisting according to an exemplary embodiment of the present invention has an advantageous effect in that an expected travel trace of a vehicle including expected front and rear wheel travel traces is displayed to predict an obstacle on the displayed expected travel trace, whereby the obstacle can be easily evaded.

### BRIEF DESCRIPTION OF DRAWINGS

The teachings of the present invention can be readily understood by considering the following detailed description in conjunction with the accompanying drawings, in which:

FIG. 1 is a schematic block diagram illustrating configuration of a display apparatus for assisting parking according to an exemplary embodiment of the present invention;

FIG. 2 is a conceptual view illustrating a method for calculating an expected (predicted) travel trace of a vehicle in a display apparatus for assisting parking according to an exemplary embodiment of the present invention;

FIG. 3 is a schematic view illustrating a scene displayed on a display unit in a display apparatus for assisting parking according to an exemplary embodiment of the present invention;

FIG. 4 is a schematic view illustrating a scene displayed on a display unit in a display apparatus for assisting parking according to another exemplary embodiment of the present invention; and

FIG. 5 is a flowchart illustrating a method for assisting parking according to an exemplary embodiment of the present invention

### BEST MODE FOR CARRYING OUT THE INVENTION

Hereinafter, exemplary embodiments of the present invention will be described in detail with reference to the accompanying drawings.

In describing the present disclosure, detailed descriptions of constructions or processes known in the art may be omitted to avoid obscuring appreciation of the invention by a person of ordinary skill in the art with unnecessary detail regarding such known constructions and functions. Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

FIG. 1 is a schematic block diagram illustrating configuration of a display apparatus for assisting parking according to an exemplary embodiment of the present invention.

The display apparatus for assisting parking according to an exemplary embodiment of the present invention comprises a plurality of photographing units (11, 12, 13 and 14) mounted on a vehicle to obtain images of all directions of the vehicle, an image combining unit (10), a travel trace generating unit (20), a controller (30), a transceiver (40), a display unit (50) and a speaker (60).

The plurality of photographing units (11 to 14) may comprise a first photographing unit (11) installed at a front side of the vehicle, a second photographing unit (12) installed at a left side of the vehicle, a third photographing unit (13) installed at a right side of the vehicle, and a fourth photographing unit (14) installed at a rear side of the vehicle.

Although an exemplary embodiment of the present invention has illustrated four (front, rear, left and right) photographing units, an exemplary embodiment of the present invention is not limited to the above-described embodiment. That is, the number of photographing units is not limited to four. For example, four or more photographing units may be included in the present invention for more accurate photographing. Furthermore, the third and fourth photographing units (13, 14) installed at left or right sides of the vehicle are generally installed at each bottom end of left and right side minors to photograph left and right sides of the vehicle, the present invention is not limited thereto.

The photographing units (11 to 14) may be, for example, such camera sensors as CCD (Charge Coupled Device) sensor or CMOS (Complementary Metal Oxide Semiconductor) sensor. However, the photographing units are not limited thereto, and other units performing similar functions as those will do.

The image combining unit (10) combines the images photographed by the photographing units (11 to 14) into an around view. The travel trace generating unit (20) receives vehicular steering angle information to generate an expectable or expected (predictable) travel trace of the vehicle, where the vehicular steering angle information is changeable in response to steering of steering wheels by a driver, and may be received by the transceiver (40).

The travel trace generating unit (20) may generate the expected travel traces of the vehicle relative to front wheels and rear wheels respectively. This is because the travel traces of front and rear wheels are different, such that, in embodying the display apparatus and method for assisting parking according to an exemplary embodiment of the present invention, the difference must be taken into consideration to reduce an error between actual vehicular travel traces and expected travel traces, and to easily avoid a collision with an obstacle during the parking. Thus, the travel trace generating unit (20) may generate a first expected travel trace made by rear wheels of the vehicle and a second expected travel trace made by front wheels of the vehicle.

Furthermore, the travel trace generating unit (20) may combine the expected vehicular travel traces with the around view and transmit the around view combined with the vehicular expected travel traces to the display unit (50) for display. In addition, the display apparatus for assisting parking according to an exemplary embodiment of the present invention may further comprise a speaker (60) to audibly notify a driver of recognition of presence of an obstacle during parking.

The display unit (50) functions to enable a driver to lay eyes on the around view combined with the vehicular expected travel traces by displaying the around view combined with the vehicular expected travel traces, whereby a driver in the vehicle mounted with the display apparatus for assisting parking according to an exemplary embodiment of the present invention can check images of substantially all directions, recognize obstacles present in all directions of the vehicle during parking, and perform an accurate parking while viewing the expected vehicular travel traces.

The controller (30) uses the transceiver (40) to receive the vehicular steering angle information in real time via CAN (Control Area Network) communication and vehicular speed information as well. The controller (30) can also control operations of the plurality of photographing units (11 to 14), the image combining unit (10), the travel trace generating unit (20), the transceiver (40), the display unit (50) and the speaker (60).

The transceiver (40) may be so configured as to directly receive the steering angle information from a steering angle measurement device (not shown) included with a steering angle sensor, and may also be so configured as to indirectly receive the steering angle information from a device capable of performing similar function equipped at the vehicle configured to receive the steering angle information. The steering angle sensor may measure a steering angle of a steering wheel necessary for control of a traveling vehicle. The travel trace generating unit (20) can generate the expected vehicular travel trace from the steering angle information received from the controller (30).

FIG. 2 is a conceptual view illustrating a method for calculating an expected (predictable) vehicular travel trace in a display apparatus for assisting parking according to an exemplary embodiment of the present invention.

In a case the front or rear photographing unit (11 or 12) is turned on, the expected (predictable) vehicular travel trace generates a plurality of coordinates based on a travel trace in response to maximum steering angle (e.g., 540 or 720) in consideration of the vehicular characteristics, and a travel trace based on a travel trace in response to minimum steering angle (e.g., a linear travel trace when a steering wheel is not rotated). For a non-limiting example, in a case a driver rotates a steering wheel at a predetermined steering angle between a maximum steering angle and a minimum steering angle, coordinates of ‘Pₙ₋₁’, ‘Pₙ₋₂’, ‘Pₙ₋₃’ and ‘Pₙ₋₄’ may be calculated in response to the predetermined steering angle, as shown in FIG. 2, and a dotted line connecting the coordinates would be an expected travel trace.

At this time, the transceiver (40) may be so configured as to directly receive the steering angle information from a steering angle measurement device included with a steering angle sensor, and may also be so configured as to indirectly receive the steering angle information from a device or a module equivalent to the steering angle sensor capable of performing similar function equipped at a vehicle configured to receive the steering angle information. The steering angle sensor may measure a steering angle of a steering wheel necessary for control of a traveling vehicle.

Thereafter, the transceiver (40) according to an exemplary embodiment of the present invention receives the steering angle information in real time via CAN communication and transmits the information to the controller (30), where the travel trace generating unit (20) can calculate proportional coordinates relative to a maximum steering angle and a minimum steering angle using the steering angle information received from the controller (30), and connect each coordinate to generate the expected vehicular travel trace.

To be more specific, X coordinate and Y coordinate of the expected vehicular travel trace may be defined by the following Math Figures, where a parking end point is exemplified as Pₙ₋₄.

MathFigure 1

Xₙ₋₄=Xₒ₋₄−Δx [Math.1]

MathFigure 2

Yₙ₋₄=Yₒ₋₄−Δy [Math.2]

where, a change (^{Δ}x) of X coordinate is (X₀₋₄−Xₑ₋₄)/(_{c}/ₘ), a change (^{Δ}y) of Y coordinate is (Y₀₋₄−Yₑ₋₄)/(_{c}/ₘ), and where ₘ is a maximum steering angle and _{c} is a minimum steering angle.

FIG. 3 is a schematic view illustrating a scene displayed on a display unit in a display apparatus for assisting parking according to an exemplary embodiment of the present invention, where a circumstance that needs a parallel parking is illustrated.

The display apparatus and method for assisting parking according to an exemplary embodiment of the present invention may utilize two types of expected vehicular travel traces, which may comprise a first expected travel trace (A) made by rear wheels of a vehicle (310) and a second expected travel trace (B) made by front wheels of the vehicle (310).

The first expected travel trace (A) defines travel traces of rear wheels of the vehicle (310), and the second expected travel trace (B) defines travel traces of front wheels of the vehicle (310). In case of using only the first expected travel trace (A) based on rear wheels of the vehicle (310), it would be difficult to predict a collision with an obstacle (320) located at a rear side of the vehicle.

In order to prevent the collision, the display apparatus and method for assisting parking according to exemplary embodiments of the present invention has added the second expected travel trace (B) based on front wheels of the vehicle (310), whereby a driver can prevent collision with the obstacle (320).

Referring to FIG. 3, the display apparatus and method for assisting parking according to exemplary embodiments of the present invention can provide the first expected travel trace (A) and the second expected travel trace (B) to the driver by displaying the first expected travel trace (A) and the second expected travel trace (B).

Additionally, in a case an obstacle exists on the first expected travel trace (A) or on the second expected travel trace (B), the first expected travel trace (A) and the second expected travel trace (B) may be visibly displayed or blinked in different colors, and the different colors of the first expected travel trace (A) and the second expected travel trace (B) may be notified to the driver.

At this time, a warning text may be outputted along with the first expected travel trace (A) and the second expected travel trace (B) to attract the driver, or the speaker (60) may be used to audibly notify the driver of existence of obstacle.

As apparent from the foregoing, the display apparatus and method for assisting parking according to exemplary embodiments of the present invention can provide expected travel traces based on both the front wheels and the rear wheels to thereby reduce an error resultant from an actual travel trace, whereby a collision with an obstacle can be avoided.

FIG. 4 is a schematic view illustrating a scene displayed on a display unit in a display apparatus for assisting parking according to another exemplary embodiment of the present invention, where a circumstance that needs a vertical parking is illustrated.

Referring to FIG. 4, an expected travel trace (D) of front wheels of a vehicle (410) is displayed to prevent a collision with an obstacle (420). Other explanatory illustrations are omitted as they are same as those in FIG. 3.

### MODE FOR THE INVENTION

FIG. 5 is a flowchart illustrating a method for assisting parking according to an exemplary embodiment of the present invention.

Referring to FIG. 5, the image combining unit (10) in the method for assisting parking according to an exemplary embodiment of the present invention analyzes the images photographed by the plurality of photographing units (11 to 14) to recognize size and/or position of an obstacle, and a distance to the obstacle, and combines the recognized information into the around view (S51).

The around view may be a scene of a vehicle viewed from an area above the vehicle, that is, a bird-eye view covering the entire circumference of the vehicle that is capable of recognizing obstacles within a predetermined range of the vehicle.

Successively, the travel trace generating unit (20) generates a first expected travel trace based on rear wheels of the vehicle and a second expected travel trace based on front wheels of the vehicle in response to the steering angle information of the vehicle (S52). Furthermore, the travel trace generating unit (20) overlays the generated first and second expected vehicular travel traces on the around view (S53) to allow the display unit (50) to display the overlaid around view along with the expected vehicular travel traces (S54).

A vehicular expected travel trace according to prior art was only an expected vehicular travel trace based on rear wheels, or only one expected vehicular travel trace, such that the preventive effect against collision with an obstacle during parking was insignificant, and an error with an actual vehicular travel trace existed to decrease reliability as a parking assistance.

Advantageously, the parking apparatus and method for parking assisting according to an exemplary embodiment of the present invention is such that expected vehicular travel traces based on front wheels and rear wheels are respectively displayed on a display unit to reduce an error with an actual vehicular travel trace, whereby reliability as a parking assistance has been enhanced to prevent collision with an obstacle can be evaded during parking.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

### INDUSTRIAL APPLICABILITY

The parking apparatus and method for parking assisting according to exemplary embodiments of the present invention have an industrial applicability in that an expected travel trace of a vehicle including expected front and rear wheel travel traces is displayed to predict an obstacle on the displayed expected travel trace, whereby the obstacle can be easily prevented.

1. A display apparatus for assisting parking, the apparatus comprising: a plurality of photographing units mounted on a vehicle to obtain images of all directions of the vehicle; an image combining unit combining the images into an around view; a travel trace generating unit generating an expected travel trace of the vehicle using steering angle information of the vehicle to overlay the expected travel trace on the around view; and a display unit displaying the overlaid around view, wherein the travel trace generating unit generates a first expected travel trace based on rear wheels of the vehicle and a second expected travel trace based on front wheels of the vehicle.

2. The apparatus of claim 1, wherein the plurality of photographing units comprises first, second, third and fourth photographing unit installed on a front side, a rear side, a left side and a right side of the vehicle to obtain an image of each direction.

3. The apparatus of claim 2, wherein the third and fourth photographing units installed on left and right sides of the vehicle are installed at bottom ends of the left and right side mirrors of the vehicle.

4. The apparatus of claim 1, wherein the around view includes a scene of the vehicle viewed from an area above the vehicle.

5. The apparatus of claim 1, further comprising a transceiver configured to receive the steering angle information.

6. The apparatus of claim 5, wherein the transceiver receives the steering angle information from a steering angle sensor of the vehicle.

7. The apparatus of claim 1, wherein the first and second expected travel traces are updated in real time in response to steering angle of steering wheels of the vehicle.

8. The apparatus of claim 1, further comprising a speaker audibly announcing a presence of an obstacle to a driver.

9. A method for assisting parking, the method comprising: combining images of all directions of a vehicle photographed by a photographing unit installed on the vehicle into an around view; generating an expected travel trace of the vehicle using steering angle information of the vehicle; overlaying the expected travel trace of the vehicle on the around view; and displaying the overlaid around view along with the expected travel trace of the vehicle, wherein the expected travel trace generating step includes generating a first expected travel trace based on rear wheels of the vehicle and a second expected travel trace based on front wheels of the vehicle.

10. The method of claim 9, wherein the around view includes a scene of the vehicle viewed from an area above the vehicle.

11. The method of claim 9, wherein the first and second expected travel traces are updated in real time in response to steering angle of steering wheels of the vehicle.
